(19) United States
(12) Patent Application Publication
(10) Pub. No.: US 2022/0382662 A1
(43) Pub. Date: Dec. 1, 2022

(54) BATTERIES HEALTH STATUS DETERMINATIONS

(71) Applicant: Hewlett-Packard Development Company, L.P., Spring, TX (US)

(72) Inventors: Ming Chang HUNG, Taipei (TW); John ROCHE, Spring, TX (US); Yi-Fan HSIA, Taipei (TW); Ling Ya WU, Taipei (TW); Hung Lung CHEN, Taipei (TW); Carla Jean ALI-NAPO, Vancouver, WA (US); Nathan Edward KOFAHL, Rio Rancho, NM (US)

(21) Appl. No.: 17/329,263

(22) Filed: May 25, 2021

(51) Int. Cl. G06F 11/34; G06F 9/4401; G06F 1/28

(52) U.S. Cl. CPC G06F 11/3466; G06F 9/4401; G06F 1/28

(57) ABSTRACT

In an example, a computing device may include a battery, a controller to monitor an operation of the battery, and a basic input/output system (BIOS). The BIOS may initiate a boot process to load an operating system of the computing device. Further, the BIOS may obtain information associated with the operation of the battery from the controller during the boot process. Furthermore, the BIOS may update a log data structure to record the obtained information. Also, the BIOS may determine a health status of the battery based on the updated log data structure and output a notification, during the boot process, indicative of health of the battery based on the determined health status.

### BACKGROUND

Portable computing devices are becoming increasingly popular. For example, the portable computing devices may include notebooks, tablets, convertible devices, or the like. Such computing devices may be powered by battery packs. The battery packs may include rechargeable batteries, such as Nickel batteries, Lithium batteries, and the like and maybe capable of providing power to the computing devices, for instance, for several hours.

### BRIEF DESCRIPTION OF THE DRAWINGS

Examples are described in the following detailed description and in reference to the drawings, in which:

FIG. 1A is a block diagram of an example computing device, including a basic input/output system (BIOS) to output a notification indicative of health of a battery during a boot process;

FIG. 1B is a block diagram of the example computing device of FIG. 1A, depicting additional features;

FIG. 2A is a block diagram of an example computing device, including a processor to output an alert message indicative of health of a battery during an operating system (OS) environment;

FIG. 2B is a block diagram of the example computing device of FIG. 2A, depicting additional features associated with a battery pack;

FIG. 3 is a block diagram of an example computing device including a non-transitory machine-readable storage medium, storing instructions to determine and store a health status of a battery during a boot process;

FIG. 4A is a block diagram of an example computing device, including a BIOS to determine health of a battery during a boot process;

FIG. 4B is a block diagram of the example computing device of FIG. 4A, depicting additional features;

FIG. 5 is a flowchart illustrating an example method for generating a battery health status report during an operating system environment;

FIG. 6 is a flowchart illustrating an example method for updating a system management BIOS (SMBIOS) table with a battery health status during a pre-boot environment; and

FIG. 7 is a flowchart illustrating an example method for displaying a warning message indicating a health status of a battery during a pre-boot environment.

### DETAILED DESCRIPTION

Rechargeable batteries may be used as a source of power to electronic devices or computing devices. A “battery capacity” or a “full charge capacity” is a measure of a charge stored by a battery and is determined by a mass of active material contained in the battery. The battery capacity may represent a maximum amount of energy that can be extracted from the battery under certain specified conditions.

The effective storage capacity of the battery, however, may diminish with age and undergo irreversible damage, thereby degrading a performance of the battery or even cause catastrophic failure. This damage may be caused by various mechanisms including corrosion or other chemical processes. Also, aging of internal battery components may contribute to the damage as well. Each charge/discharge cycle of the battery may also have a similar effect but at an accelerated rate. Furthermore, an elevated temperature may lead to swelling of the batteries and may minimize the life of the batteries. Accordingly, battery deterioration may be the result of the charge cycle aging (e.g., occurs due to battery charge/discharge cycles), calendar aging (e.g., occurs when the battery sits idle), an elevated temperature, and/or the like. The end result is that, as the battery ages and deteriorates, the effective capacity of the battery decreases, thereby reducing the amount of time the battery can supply power to a computing device.

One indicator of the battery's ability to retain charge and ability to power the computing device is the battery's “state of health”, which may be estimated based on the effective full charge capacity and parameters described above. Many monitoring applications may use the above parameters to estimate the battery performance (e.g., a “run-time” or “lifespan” of the battery), which reflects the amount of time the battery can continue to provide power before the battery dies. However, such monitoring applications may be written specific to a particular operating system (OS), and hence may not be able to operate with other operating systems.

In other examples, batteries may be associated with or coupled to monitoring devices or circuits that can measure, track, record, and/or report other battery characteristics and states. For example, some batteries may include or be coupled to electronic circuits or devices that store identification information, battery specifications (e.g., energy capacity specifications), manufacturing information (e.g., manufacturer, build dates, and the like), and the like. Such circuits and devices can also include testing capabilities to measure a current full charge capacity, resting discharge rate, operating temperature, and the like. However, such monitoring devices or circuits may involve additional hardware and increased costs.

Examples described herein may provide a computing device having a battery, a controller to monitor an operation of the battery, and a basic input/output system (BIOS). During a boot process of the computing device, the BIOS may obtain information associated with the operation of the battery from the controller. Further, the BIOS may update a log data structure to record the obtained information. Furthermore, the BIOS may determine a health status of the battery based on the updated log data structure, for instance, via applying a machine learning model (e.g., a linear regression model).

In an example, the BIOS may output a notification, during the boot process, indicative of health of the battery based on the determined health status. In another example, the BIOS may store the health status in an interface table (e.g., a system management BIOS (SMBIOS) table) during the boot process. Further, upon loading an operating system (OS) of the computing device, a processor of the computing device may retrieve the health status of the battery from the interface table and output a notification indicative of the health of the battery based on the retrieved health status.

Thus, examples described herein may enable a system firmware (e.g., the BIOS) to proactively determine the health status of the battery and generate various warning messages (e.g., bad battery, discharging abnormal, remain battery capability is not enough, or the like) based on the determined health status. In this example, the BIOS may determine the health status of the battery independent of the operating system of the computing device. Also, examples described herein may be utilized in an internet of things (IoT) environment, for instance, to determine a battery health status of a connected device in the IoT environment.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

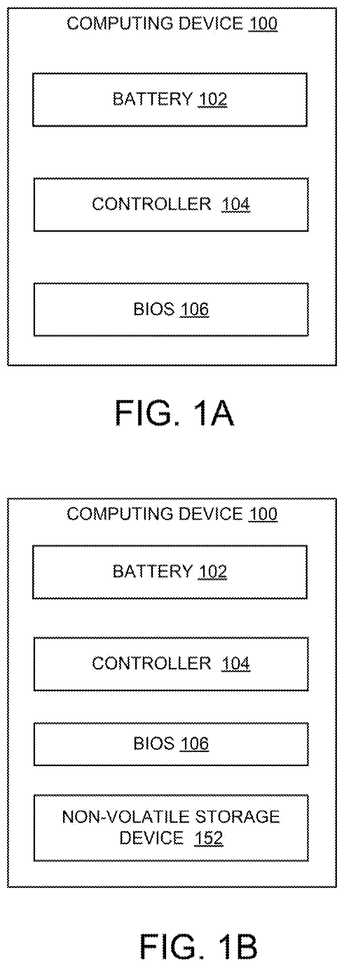

Turning now to the figures, FIG. 1A is a block diagram of an example computing device 100, including a BIOS 106 to output a notification indicative of health of a battery 102 during a boot process. Example computing device 100 may include a notebook, a tablet, a smartphone, a workstation, or the like.

Computing device 100 may include battery 102. For example, battery 102 may refer to a hardware component that supplies power to computing device 100, enabling computing device 100 to operate without a power cord (i.e., without being connected to an external power supply). Further, computing device 100 may include a controller 104 to monitor an operation of battery 102. Example controller 104 may be a chip (e.g., a microcontroller), an expansion card, a stand-alone device, or the like to perform various operations associated with battery 102. In an example, controller 104 may periodically communicate with battery 102 through system management bus (SMBus) and update battery information in a storage device (e.g., embedded controller random access memory (ECRAM)).

For example, controller 104 may monitor the operation of battery 102 to obtain and store information associated with the operation of battery 102. Example information may include full charge capacity data (e.g., currently monitored) for battery 102, temperature data for battery 102, charge cycle data for battery 102, charging behavior data (e.g., charge and discharge data) for battery 102, or any combination thereof.

Further, computing device 100 may include BIOS 106. As used herein, BIOS 106 refers to hardware or hardware and instructions to initialize, control, or operate computing device 100 prior to execution of an operating system of computing device 100. Instructions included within BIOS 106 may be software, firmware, microcode, or other programming that defines or controls functionality or operation of BIOS 106. In an example, BIOS 106 may be implemented using instructions, such as platform firmware of computing device 100, executable by a processor. BIOS 106 may operate or execute prior to the execution of the operating system of computing device 100. BIOS 106 may initialize, control, or operate components such as hardware components of computing device 100 and may load or boot the operating system of computing device 100.

In some examples, BIOS 106 may provide or establish an interface between hardware devices or platform firmware of computing device 100 and the operating system of computing device 100, via which the operating system of computing device 100 may control or operate hardware devices or platform firmware of computing device 100. In some examples, BIOS 106 may implement the Unified Extensible Firmware Interface (UEFI) specification or another specification or standard for initializing, controlling, or operating computing device 100.

During operation, BIOS 106 may initiate a boot process to load the operating system of computing device 100. Further, BIOS 106 may obtain the information associated with the operation of battery 102 from controller 104 during the boot process. For example, BIOS may obtain the information from the ECRAM through an input/output port. BIOS 106 may update a log data structure to record the obtained information with associated time stamps. For example, the log data structure may also include historical information associated with battery 102.

Further, BIOS 106 may determine a health status (e.g., a storage capacity deterioration) of battery 102 based on the updated log data structure. In an example, BIOS 106 may determine a full charge capability of battery 102, a time period of charge cycle of battery 102, a temperature of battery 102, or any combination thereof from the updated log data structure. In an example, the time period of charge cycle may indicate a charge and discharge speed of battery 102.

Furthermore, BIOS 106 may determine the health status of battery 102 in response to a determination that the full charge capability of battery 102 is less than a first threshold, the time period of charge cycle of battery 102 is greater than a second threshold, the temperature of battery 102 is greater than a third threshold, or any combination thereof. For example, the health status of battery 102 may indicate a criticality level or a level of user impact (e.g., high, medium, or low).

In another example, BIOS 106 may determine the health status of battery 102 via applying a machine learning model to the updated log data structure. Example machine learning model may include a classification and regression model. In this example, BIOS 106 may apply the classification and regression model to the updated log data structure to:
classify historical information and the obtained information in the updated log data structure, and
predict the health status of battery 102 using the classified information.

For example, the health status of battery 102 can be defined by full charge capacity data, temperature data, and charge cycle data for battery 102. In an example, the health status (e.g., a lifespan indicative of an end of life) of battery 102 can be defined by a charge cycle count at which the full charge capacity of battery 102 degrades below a particular threshold. Such analysis may be performed by applying the machine learning model to the updated log data structure.

Furthermore, BIOS 106 may output a notification, during the boot process, indicative of the health of battery 102 based on the determined health status. The notification may be displayed on a display screen of computing device 100. Example notification may include a critical message or a warning message such as a bad battery warning status, a discharging abnormal warning status, a warning status that remaining battery capability is not enough, or the like.

For example, when the health status indicates a “high” level of user impact, BIOS 106 may output a critical message indicating “battery 102 has to be replaced immediately”. In another example, when the health status indicates a “medium” level of user impact, then BIOS 106 may output a warning message indicating “battery 102 has to be replaced during a next scheduled maintenance”. Thus, examples described herein may provide various warning messages corresponding to different battery health statuses in a pre-boot environment.

FIG. 1B is a block diagram of example computing device 100 of FIG. 1A, depicting additional features. For example, similarly named elements of FIG. 1B may be similar in structure and/or function to elements described with respect to FIG. 1A. As shown in FIG. 1B, computing device 100 may include a non-volatile storage device 152. Example non-volatile storage device 152 may be a BIOS memory or in any other storage device that can be accessible to BIOS 106. Non-volatile storage device 152 may store the log data structure including the historical information associated with battery 102. An example log data structure may be a log file (e.g., 32 bytes) to store information associated with battery 102 and timestamps associated with the information. In this example, BIOS 106 may update the log data structure in non-volatile storage device 152 to record the obtained information along with associated timestamps. In other examples, the functions/operations described in FIGS. 1A and 1B may also be implemented using a microcontroller unit (MCU).

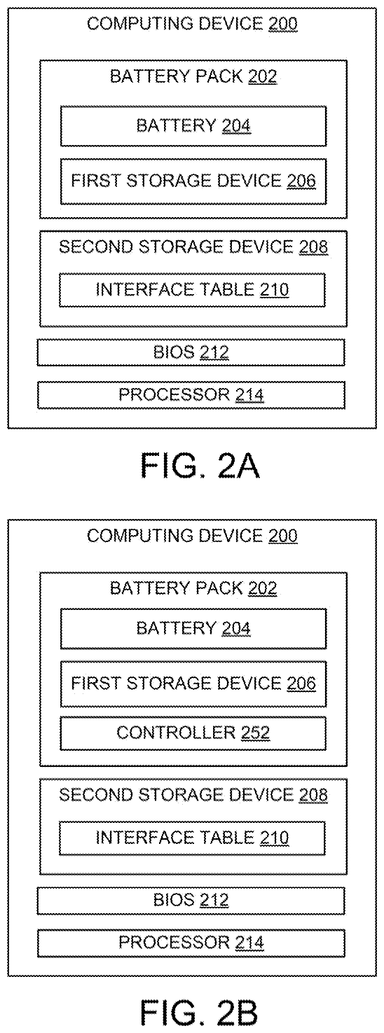

FIG. 2A is a block diagram of an example computing device 200, including a processor 214 to output an alert message indicative of health of a battery 204 during an operating system environment. Computing device 200 may include a battery pack 202. For example, battery pack 202 may refer to a rechargeable battery pack with a built-in battery management system (BMS), for use in computing device 200 (e.g., a laptop). Battery pack 202 may include battery 204 and a first storage device 206 to store information associated with an operation of battery 204. An example battery pack 202 is explained with respect to FIG. 2B.

FIG. 2B is a block diagram of example computing device 200 of FIG. 2A, depicting additional features associated with battery pack 202. For example, similarly named elements of FIG. 2B may be similar in structure and/or function to elements described with respect to FIG. 2A. As shown in FIG. 2B, battery pack 202 may include a controller 252 to monitor the operation of battery 204. Further, controller 252 may determine the information associated with the operation of battery 204 based on the monitoring. Furthermore, controller 252 may store the determined information in first storage device 206. Also, controller 252 may control a charging operation of battery 204. In other examples, electronic device may include another controller that is external to battery pack 202. In this example, the external controller may periodically communicate with controller 252 through SMBus, obtain the information from controller 252 of battery pack 202, and store the obtained information into a storage device.

In an example, controller 252 may manage various battery operations and monitor various battery conditions. For example, controller 252 may measure a voltage of battery 204, a current of battery 204, a time and/or a time period of charge/discharge cycle (i.e., charge cycle data) of battery 204, and the like. In another example, controller 252 may store initial battery characteristics (e.g., characteristics of battery 204 when battery 204 is new) such as an initial full charge capacity, known battery data (e.g., data relating to the capacity of battery 204 as battery 204 ages), and the like. In yet another example, controller 252 may store full charge capacity data as a function of time and full charge capacity data as a function of the charge cycle count (e.g., a number of times the battery has been drained and recharged). The full charge capacity data as a function of time and the full charge capacity data as a function of the charge cycle count may be obtained by testing battery 204 over a period of time (e.g., 40 months). In yet another example, controller 252 may monitor charge and discharge processes of battery 204 and store charging behavior data associated with battery 204 based on the monitoring. In yet another example, controller 252 may include a temperature sensor to measure temperature data of battery 204.

Referring back to FIG. 2A, computing device 200 may include a second storage device 208 having an interface table 210 or any other type of data structure. Example second storage device 208 may be a BIOS Flash storage. In an example, interface table 210 may act as a standard interface to the operating system such that the operating system can access and retrieve information generated by a BIOS 212 of computing device 200. Example, interface table 210 may be a system management BIOS (SMBIOS) table or any other standard interface table such as a windows management instrumentation (WMI) table.

Further, computing device 200 may include BIOS 212. During operation, BIOS 212 may obtain the information associated with the operation of battery 204 from first storage device 206 during a boot process of computing device 200. In an example, BIOS 212 may obtain the information from first storage device 206 via the external controller. Furthermore, computing device 200 may update a log data structure to record the obtained information. In an example, the log data structure may be stored in a non-volatile BIOS memory.

BIOS 212 may determine a health status of battery 204 using the updated log data structure. In an example, BIOS 212 may determine the health status of battery 204 via applying a machine learning model to the updated log data structure. For example, the updated log data structure may include historical information and the obtained information of battery 204. Example machine learning model may be a classification and regression model.

In an example, BIOS 212 may determine a current full charge capability, a charge cycle, a remaining capacity, and a temperature of battery 204 based on the obtained information. Further, BIOS 212 may estimate the health status of battery 204 according to the determined parameters and/or known parameters, such as initial full charge capability, the current full charge capability, the charge cycle, the remaining capacity, and/or the battery temperature. In other examples, BIOS 212 may also consider whether a power cord that charges battery 204 is connected to computing device 200 (e.g., as indicated in the obtained information) to estimate the health status.

Example health status of battery 204 may include a lifespan of battery 204, a storage capacity deterioration of battery 204, a remaining capability of battery 204, or the like. In an example, BIOS 212 may estimate a storage capacity deterioration value from the current full charge capability and the battery temperature, based on storage deterioration characteristics according to battery capacities and ambient temperatures.

Further, BIOS 212 may store the health status in interface table 210. BIOS 212 may load the operating system of computing device 200 upon storing the health status. Furthermore, computing device 200 may include processor 214. For example, processor 214 may be a type of central processing unit (CPU), microprocessor, or processing logic that interprets and executes machine-readable instructions stored in machine-readable storage medium in a memory of computing device 200.

During operation, processor 214 may retrieve the health status of battery 204 from interface table 210 upon loading the operating system. In an example, processor 214 may retrieve the health status of battery 204 from interface table 210 via an SMBIOS interface or a WMI interface. Further, processor 214 may output an alert message indicative of health of battery 204 based on the retrieved health status.

In an example, processor 214 may output the alert message seeking a user confirmation to send the health status to a management application executing in a server. Further, processor 214 may send, via a network, the health status to the management application in response to the user confirmation. For example, the management application, upon receiving the health status, may send a recommendation to an administrator to replace battery 204.

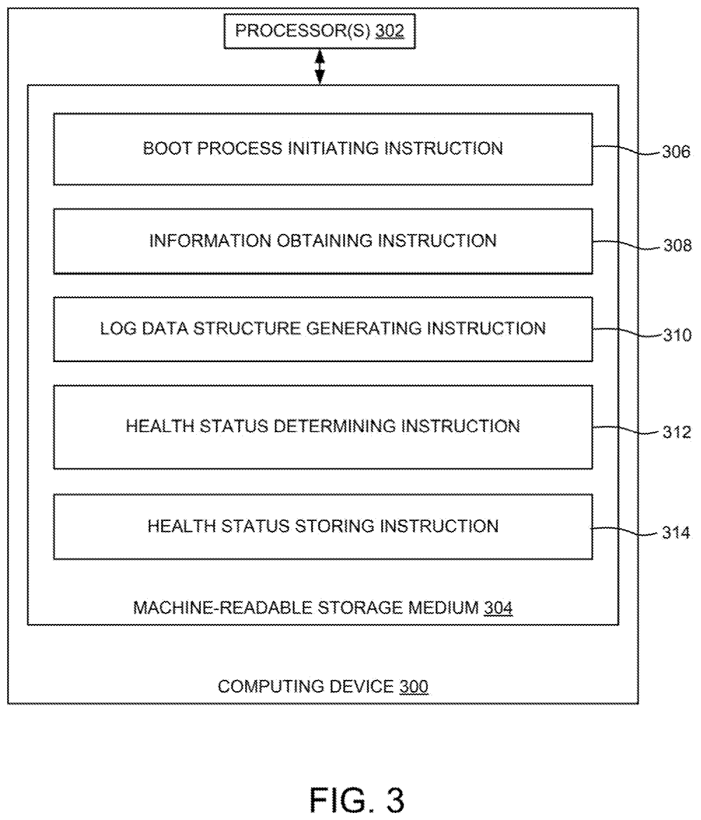

FIG. 3 is a block diagram of an example computing device 300 including a non-transitory machine-readable storage medium 304, storing instructions to determine and store a health status of a battery during a boot process. Computing device 300 may include a processor 302 and machine-readable storage medium 304 communicatively coupled through a system bus. Processor 302 may be any type of central processing unit (CPU), microprocessor, or processing logic that interprets and executes machine-readable instructions stored in machine-readable storage medium 304.

Machine-readable storage medium 304 may be a random-access memory (RAM) or another type of dynamic storage device that may store information and machine-readable instructions that may be executed by processor 302. For example, machine-readable storage medium 304 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 304 may be a non-transitory machine-readable medium, where the term “non-transitory” does not encompass transitory propagating signals. In an example, machine-readable storage medium 304 may be remote but accessible to computing device 300.

Machine-readable storage medium 304 may store instructions 306-314. In an example, instructions 306 may be executed by processor 302 to initiate a boot process to load an operating system of computing device 300. Instructions 308 may be executed by processor 302 to obtain information associated with an operation of the battery during the boot process. Example information associated with the operation of the battery may include full charge capacity data for the battery, temperature data for the battery, charge cycle data for the battery, charging behavior data for the battery, or any combination thereof.

Instructions 310 may be executed by processor 302 to generate a log data structure to record the obtained information during the boot process. Instructions 312 may be executed by processor 302 to determine a health status of the battery during the boot process via applying a machine learning model stored in computing device 300 to the information in the log data structure. In an example, instructions to determine the health status of the battery via applying the machine learning model may include instructions to apply a classification and regression model to the log data structure to:
classify the information in the log data structure, and
predict the health status of the battery using the classified information.

In some examples, machine-readable storage medium 304 may store instructions to train the machine learning model using a training data set (e.g., historical battery information). In this example, the instructions may:
initiate training of the machine learning model during the boot process,
train the machine learning model using the training dataset to generate a set of feature weights corresponding to a set of features of the machine learning model, and
store the set of feature weights in computing device 300.

In the above example, the health status of the battery may be determined via applying the machine learning model based on the set of feature weights corresponding to a set of features (e.g., a charging frequency, a charge cycle time period, a temperature value, or the like). In an example, instructions to determine the health status of the battery via applying the machine learning model may include instructions to:
determine a full charge capacity of the battery via applying a classification and regression model to the information in the log data structure, and
determine the health status of the battery via applying another classification and regression model to the information in the log data structure based on the full charge capacity of the battery.

In another example, instructions to determine the health status of the battery via applying the machine learning model may include instructions to:
determine a time period of charge cycle of the battery via applying a classification and regression model to the information in the log data structure, and
determine the health status of the battery via applying another classification and regression model to the information in the log data structure based on the time period of charge cycle of the battery.

In another example, instructions to determine the health status of the battery via applying the machine learning model may include instructions to:
determine an internal temperature of the battery via applying a classification and regression model to the information in the log data structure, and
determine the health status of the battery via applying another classification and regression model to the information in the log data structure based on the internal temperature of the battery.

Instructions 314 may be executed by processor 302 to store the health status in a storage device of computing device 300 during the boot process. In an example, machine-readable storage medium 304 may store instructions to output a notification indicative of health of the battery during the boot process based on the stored health status.

In another example, machine-readable storage medium 304 may store instructions to:
load the operating system of computing device 300 upon storing the health status,
retrieve the health status of the battery from the storage device via an application programming interface upon loading the operating system, and
output an alert message indicative of the health of the battery based on the retrieved health status.

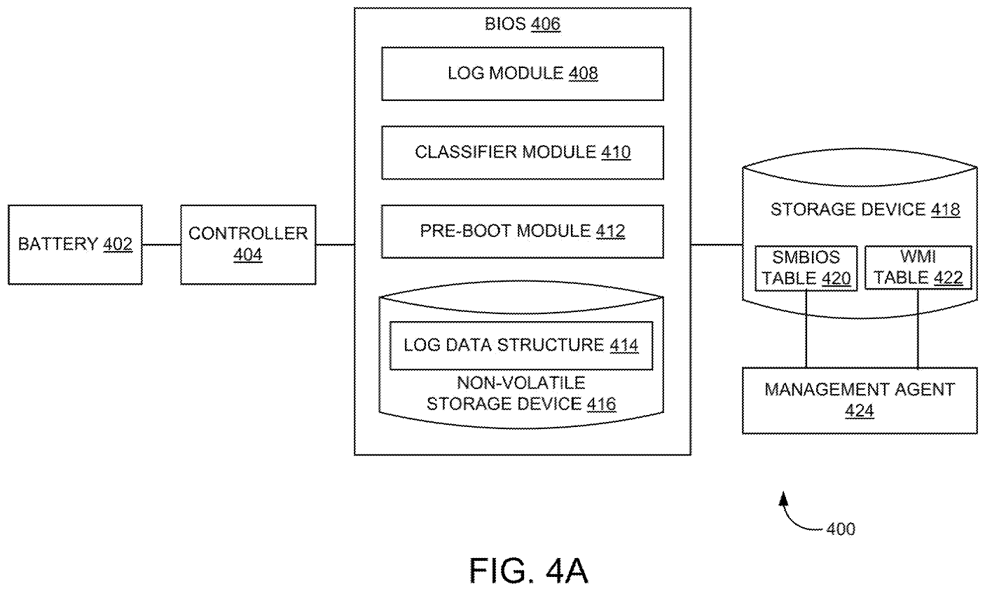

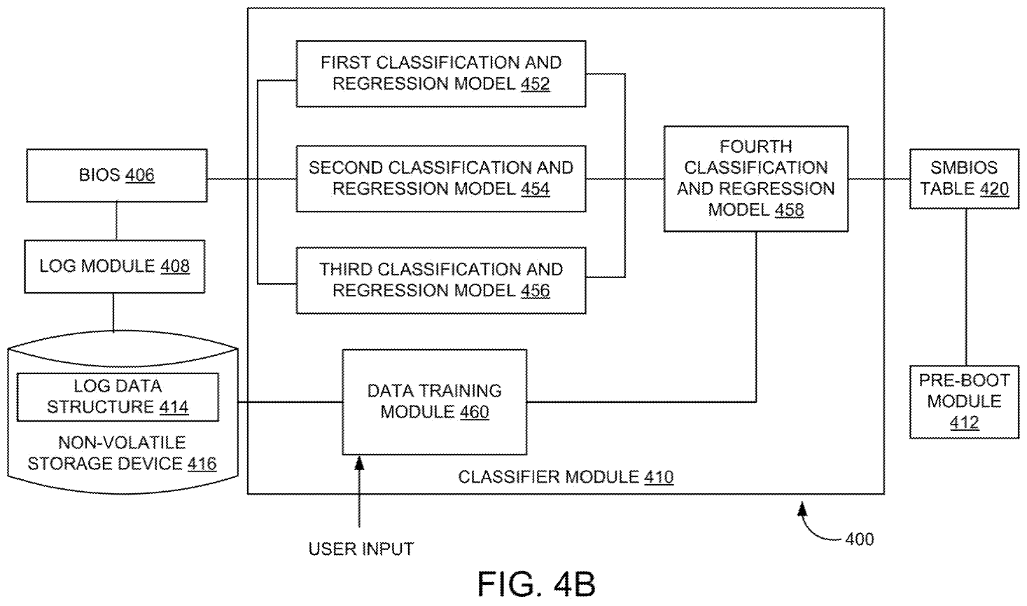

FIG. 4A is a block diagram of an example computing device 400, including a BIOS 406 to determine health of a battery 402 during a boot process. As shown in FIG. 4A, computing device 400 may include battery 402, a controller 404, BIOS 406, and a management agent 424. Further, BIOS 406 may include a log module 408, a classifier module 410, a pre-boot module 412, and a non-volatile storage device 416.

During operation, controller 404 may periodically communicate with battery 402 to obtain information associated with an operation of battery 402. Further, BIOS 406 may obtain the information associated with the operation of battery 402 via controller 404 during the boot process. When a log data structure 414 (e.g., a log file) is not available in non-volatile storage device 416, log module 408 may create log data structure 414 in non-volatile storage device 416. Further, log module 408 may record the obtained information in created log data structure 414. When log data structure 414 is available in non-volatile storage device 416, log module 408 may update log data structure 414 with the obtained information. An example log data structure 414 may be a log file having 32 bytes to store information associated with battery 402.

Further, classifier module 410 may determine a health status of battery 402 based on updated log data structure 414. In an example, classifier module 410 may apply a classification and regression model to log data structure 414 to determine the health status of battery 402 as described in FIG. 4B. Further, classifier module 410 may store the health status of battery 402 in an interface table (e.g., an SMBIOS table 420, a WMI table 422, or the like) of a storage device 418. In an example, storage device 418 may be a volatile storage device.

In an example, during the boot process, pre-boot module 412 may retrieve the health status from SMBIOS table 420 or WMI table 422 and generate a notification indicative of the health of battery 402 based on the retrieved health status. In another example, upon loading the operating system, management agent 424 may retrieve the health status from SMBIOS table 420 or WMI table 422. For example, management agent 424 may access SMBIOS table 420 in accordance with an SMBIOS specification via an SMBIOS interface (e.g., an operating system application programming interface). Further, management agent 424 may access WMI table 422 in accordance with a WMI specification via a WMI interface.

Further, management agent 424 may output an alert message indicative of health of battery 402 based on the retrieved health status. In yet another example, management agent 424 may output the alert message seeking a user confirmation to send the health status to a server and send the health status to the server in response to the user confirmation.

FIG. 4B is a block diagram of example computing device 400 of FIG. 4A, depicting additional features. For example, similarly named elements of FIG. 4B may be similar in structure and/or function to elements described with respect to FIG. 4A. As shown in FIG. 4B, classifier module 410 may include a first classification and regression model 452, a second classification and regression model 454, a third classification and regression model 456, and a fourth classification and regression model 458.

During operation, classifier module 410 may determine a full charge capacity of battery 402 (e.g., as shown in FIG. 4A) via applying first classification and regression model 452 to the information in updated log data structure 414. When the full charge capability of battery 402 is less than a first threshold, classifier module 410 may determine the health status of battery 402 via applying a fourth classification and regression model 458 to the information in updated log data structure 414. In this example, fourth classification and regression model 458 may determine a criticality level of battery 402.

In another example, classifier module 410 may determine a time period of charge cycle of battery 402 via applying second classification and regression model 454 to the information in updated log data structure 414. When the time period of charge cycle of battery 402 is greater than a second threshold, classifier module 410 may determine the health status of battery 402 via applying fourth classification and regression model 458 to the information in updated log data structure 414.

In yet another example, classifier module 410 may determine an internal temperature of battery 402 via applying third classification and regression model 456 to the information in updated log data structure 414. When the temperature of battery 402 is greater than the third threshold, classifier module 410 may determine the health status of battery 402 via applying fourth classification and regression model 458 to the information in updated log data structure 414.

When the temperature of battery 402 is not greater than the third threshold, when the time period of charge cycle of battery 402 is not greater than the second threshold, and when the determined full charge capability of battery 402 is not less than the first threshold, pre-boot module 412 may load the operating system of computing device 400. When the full charge capability of battery 402 is less than the first threshold, when the time period of charge cycle of battery 402 is greater than the second threshold, and/or when the temperature of battery 402 is greater than the third threshold, classifier module 410 may update SMBIOS table 420 with the determined health status of battery 402.

In this example, pre-boot module 412 may retrieve the health status from SMBIOS table 420 and generate a notification (e.g., a warning message) indicative of the health of battery 402 based on the retrieved health status. For example, the warning message may include a storage capacity deterioration, a remaining capability, a recommendation to replace battery 402, a recommendation to charge battery 402, or the like.

In other examples, classifier module 410 may include a data training module 460 to train classification and regression models 452, 454, 456, and 458 during the boot process, for instance, upon receiving a user input. For example, during the boot process, a hot key (e.g., F10) can be pressed in a keyboard to allow computing device 400 to enter a BIOS setup menu. Further, the BIOS setup menu may provide an option to launch training of classification and regression models 452, 454, 456, and/or 458.

For example, the training of classification and regression model may include:
receiving the training data corresponding to a period,
adjusting the classification and regression model according to the training data,
testing the classification and regression model, and
optimizing, employing prior knowledge, the classification and regression model. In an example, optimizing the classification and regression model may include applying feature weights to features of the classification and regression model, to form an optimized classification and regression model.

During operation, the optimized classification and regression model may be employed to classify operational data (i.e., information in the updated log data structure 414) to adapt the feature weights. The feature weights may be applied to features of the classification and regression model during the optimization. In an example, the classification and regression model may be a natural language understanding model and the features weights may include natural language understanding feature weights or machine learning feature weights.

In an example, the features of fourth classification and regression model 458 may include a charging frequency, a charge cycle time period, a temperature value, and the like. Further, a full charge capability below the first threshold may indicate that the health status of battery 402 may have a user impact. In this example, battery 402 may have to be replaced either immediately or as per schedule based on a charging frequency per day. In an example, when the current full charge capability is below the first threshold and the battery charging behavior (e.g., a battery charging frequency per day in last 7 days) is above a feature weight value of the charging frequency, then a critical message indicating “battery 402 has to be replaced immediately” may be outputted. In another example, when the current full charge capability is below the first threshold and the battery charging behavior is below the feature weight value of the charging frequency, then a warning message indicating “battery 402 has to be replaced as per schedule” may be outputted.

Similarly, a charge cycle over the second threshold may indicate that the health status of battery 402 may have a user impact. In this example, battery 402 may have to be replaced either immediately or as per schedule based on the charge cycle time period. The charge cycle time period may refer to battery charging and discharging speed. A “high value” of the time period may have a low user impact (i.e., a low charge and discharge speed) and a “low value” of the time period may have a high user impact (i.e., a high charge and discharge speed). In an example, when the charge cycle is above the second threshold and the charge cycle time period (e.g., from n to n+1 in last 7 day) is below a feature weight value of the charge cycle time period, then a critical message indicating “battery 402 has to be replaced immediately” may be outputted. When the charge cycle is above the second threshold and the charge cycle time period (e.g., from n to n+1 in last 7 day) is above the classification weight value of the charge cycle time period, then a warning message indicating “battery 402 has to be replaced as per schedule” may be outputted.

Similarly, when the battery temperature is above the third threshold and battery temperature is above a feature weight value of the battery temperature, a critical message indicating “battery 402 has to be replaced immediately” may be outputted. When the battery temperature is above the third threshold and the battery temperature is below the feature weight value of battery temperature, a warning message indicating “battery 402 temperature is high and battery 402 has to be replaced as per schedule” may be outputted.

In some examples, the functionalities described in FIGS. 4A and 4B, in relation to instructions to implement functions of controller 404, log module 408, classifier module 410, pre-boot module 412, management agent 424, data training module 460, and any additional instructions described herein in relation to the storage medium, may be implemented as engines or modules including any combination of hardware and programming to implement the functionalities of the modules or engines described herein. The functions of controller 404, log module 408, classifier module 410, pre-boot module 412, management agent 424, and data training module 460 may also be implemented by a respective processor. In examples described herein, the processor may include, for example, one processor or multiple processors included in a single device or distributed across multiple devices.

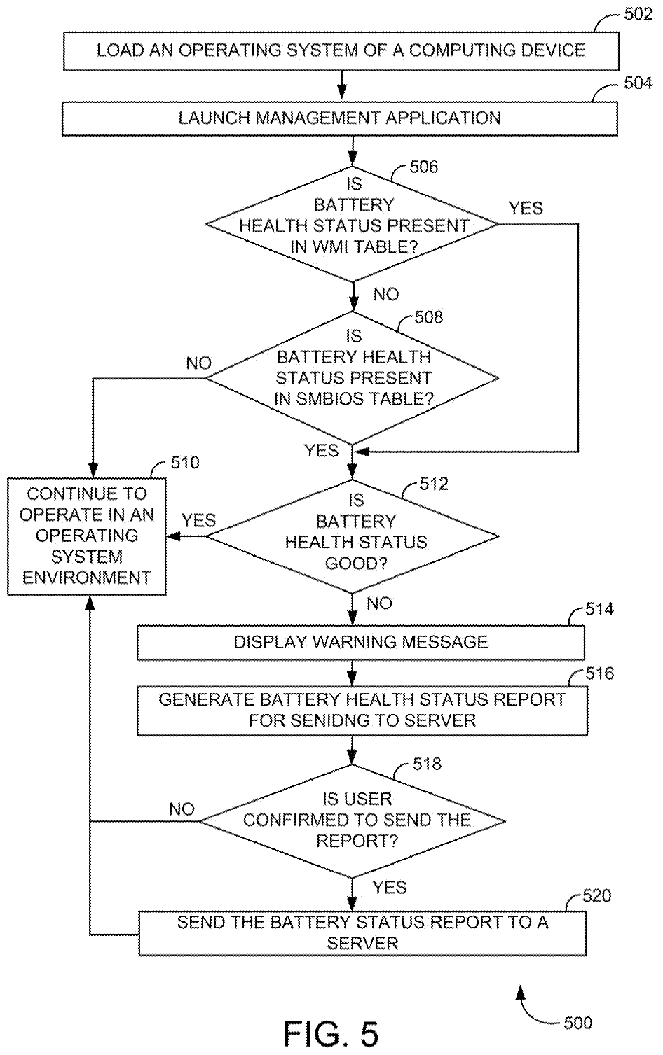

FIG. 5 is a flowchart illustrating an example method 500 for generating a battery health status report during an operating system environment. At 502, an operating system of a computing device may be loaded. At 504, a management application may be launched. An example management application may be a program-defined virtual device that leverages on an update service provided by an operating system vendor. At 506, a check may be made to determine whether a battery health status is present in a WMI table. When the battery health status is present in the WMI table, method 500 goes to block 512. When the battery health status is not present in the WMI table, a check may be made to determine whether the battery health status is present in an SMBIOS table, at 508. When the battery health status is not present in the SMBIOS table, the computing device may continue to operate in the operating system environment, at 510. When the battery health status is present in the SMBIOS table, method 500 goes to block 512.

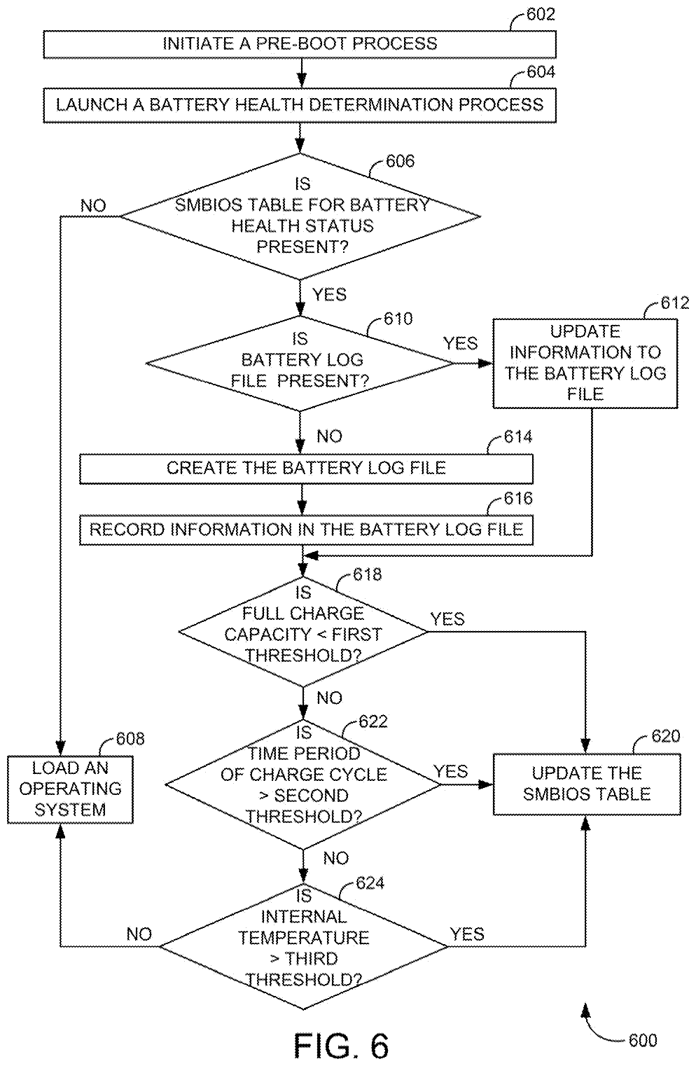

At 512, a check may be made to determine whether the battery health status is good. When the battery health status is good, the computing device may continue to operate in the operating system environment, at 510. When the battery health status is not good, a warning message corresponding to the battery health status may be displayed, at 514. An example warning message is described in FIG. 6.

At 516, a battery health status report may be generated for sending to a server, for instance, for infrastructure management. At 518, a check may be made to determine whether a user has confirmed to send the battery health status report. When the user confirms to send the battery health status report, the battery health status report may be sent to the server, at 520. When the user rejects to send the battery health status report, the computing device may continue in operate in the operating system environment, at 510.

FIG. 6 is a flowchart illustrating an example method 600 for updating an SMBIOS table with a battery health status during a pre-boot environment. At 602, a pre-boot process may be initiated. At 604, a battery health determination process may be launched. At 606, a check may be made to determine whether an SMBIOS table for the battery health status is present. When the SMBIOS table for the battery health status is not present, an operating system (OS) of the computing device may be loaded, at 608.

When the SMBIOS table for the battery health status is present, a check may be made to determine whether a battery log file is present in a non-volatile storage device (e.g., a non-volatile BIOS memory), at 610. When the battery log file is present, the battery log file may be updated with battery information (e.g., full charge capacity data, temperature data, charge cycle data, charging behavior data, and/or the like) at 612, and method 600 may be continued at 618. When the battery log file is not present, the battery log file may be created in the non-volatile storage device, at 614. At 616, the battery information may be recorded in the created battery log file, and method 600 may be continued at 618.

At 618, a check may be made to determine whether a full charge capacity of the battery is less than a first threshold. When the full charge capacity of the battery is less than the first threshold, the SMBIOS table may be updated to include the battery health status (e.g., a battery bad health status), at 620. When the full charge capacity of the battery is not less than the first threshold, a check may be made to determine whether a charge cycle of the battery is greater than a second threshold, at 622. When the charge cycle of the battery is greater than the second threshold, the SMBIOS table may be updated to include the battery health status, at 620.

Further, when the charge cycle of the battery is not greater than the second threshold, a check may be made to determine whether an internal temperature of the battery is greater than a third threshold, at 624. When the internal temperature of the battery is greater than the third threshold, the SMBIOS table may be updated to include the battery health status, at 620. When the internal temperature of the battery is not greater than the third threshold, the operating system of the computing device may be loaded, at 608. In other examples, upon updating the SMBIOS table to include the battery health status, the operating system of the computing device may be loaded.

In some examples, when the full charge capacity of the battery is less than the first threshold, the charge cycle of the battery is greater than the second threshold, and/or when the internal temperature of the battery is greater than the third threshold, the battery information including charging behavior may be analyzed to determine a battery health status including a criticality level of the battery and then the SMBIOS table may be updated to include the criticality level.

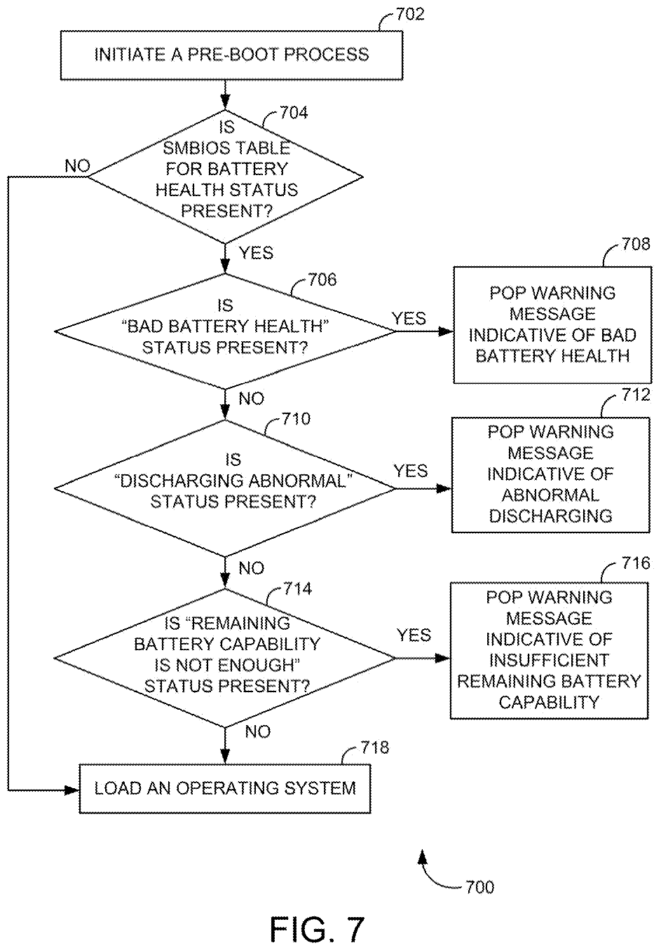

FIG. 7 is a flowchart illustrating an example method 700 for displaying a warning message indicating a health status of a battery during a pre-boot environment. At 702, a pre-boot process may be initiated. At 704, a check may be made to determine whether a SMBIOS table for a battery health status is present. When the SMBIOS table for the battery health status is not present, an operating system of the computing device may be loaded, at 718.

When the SMBIOS table for the battery health status is present, a check may be made to determine whether the battery health status indicates a “bad battery health”, at 706. When the battery health status indicates the “bad battery health”, a warning message indicative of the bad battery health may be displayed, at 708.

When the battery health status does not indicate the “bad battery health”, a check may be made to determine whether the battery health status indicates an abnormal discharging of the battery, at 710. When the battery health status indicates the abnormal discharging, the warning message indicative of abnormal charging/discharging of the battery may be displayed, at 712.

When the battery health status does not indicate the abnormal discharging, a check may be made to determine whether the battery health status indicates that a remaining battery capability is not enough, for instance, to load the operating system, at 714. When the battery health status indicates that the remaining battery capability is not enough, the warning message indicative of an insufficient remaining battery capability may be displayed, at 716. When the battery health status indicates that the remaining battery capability is enough, the operating system of the computing device may be loaded, at 718. Similarly, any other warning message indicative of a criticality level of the battery and/or an associated recommendation (e.g., to place the battery) can be generated and outputted on a display of the computing device.

Example methods 500, 600, and 700 depicted in FIGS. 5, 6, and 7 may represent generalized illustrations, and that other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. The processes of methods 500, 600, and 700 may represent functions and/or actions performed by functionally equivalent circuits like analog circuits, digital signal processing circuits, application specific integrated circuits (ASICs), or other hardware components associated with the system. Furthermore, example methods 500, 600, and 700 may not be intended to limit the implementation of the present application, but rather example methods 500, 600, and 700 may illustrate functional information to design/fabricate circuits, generate machine-readable instructions, or use a combination of hardware and machine-readable instructions to perform the illustrated processes.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

1. A computing device comprising:
a battery;
a processor to monitor an operation of the battery;
a non-volatile storage device to store a log data structure including historical information associated with the battery; and
a basic input/output system (BIOS) to:
initiate a boot process to load an operating system of the computing device; and
during the boot process:
obtain information associated with the operation of the battery from the processor;
update the log data structure to record the obtained information;
determine a health status of the battery based on the historical information and the obtained information in the updated log data structure;
generate a warning message including a criticality level of the battery and a recommendation based on the determined health status; and
output the warning message that is utilized to replace the battery or to charge the battery in accordance with the recommendation.

2. (canceled)

3. The computing device of claim 1, wherein the information comprises full charge capacity data for the battery, temperature data for the battery, charge cycle data for the battery, charging behavior data for the battery, or any combination thereof.

4. The computing device of claim 3, wherein the BIOS is to:
determine a full charge capability of the battery, a time period of charge cycle of the battery, a temperature of the battery, or any combination thereof from the updated log data structure; and
determine the health status of the battery in response to a determination that the full charge capability of the battery is less than a first threshold, the time period of charge cycle of the battery is greater than a second threshold; the temperature of the battery is greater than a third threshold, or any combination thereof.

5. The computing device of claim 1, wherein the BIOS is to:
apply a classification and regression model to the updated log data structure to:
classify the historical information and the obtained information in the updated log data structure; and
predict the health status of the battery using the classified information.

6. A computing device comprising:
a battery pack comprising:
a battery; and
a first storage device to store information associated with an operation of the battery;
a second storage device having an interface table;
a basic input/output system (BIOS) to:
during a boot process:
obtain the information associated with the operation of the battery from the first storage device;
update a log data structure to record the obtained information, the log data structure including historical information associated with the battery;
determine a health status of the battery using the historical information and the obtained information in the updated log data structure;
store the health status in the interface table; and
load an operating system of the computing device upon storing the health status; and
a processor to:
upon loading the operating system:
retrieve the health status of the battery from the interface table;
generate a warning message including a criticality level of the battery and a recommendation based on the retrieved health status; and
output the warning message that is utilized to replace the battery or to charge the battery in accordance with the recommendation.

7. The computing device of claim 6, wherein the processor is to:
output the warning message seeking a user confirmation to send the health status to a management application executing in a server; and
send, via a network, the health status to the management application in response to the user confirmation.

8. The computing device of claim 6, wherein the processor is to retrieve the health status of the battery from the interface table via a system management BIOS (SMBIOS) interface or a windows management instrumentation (WMI) interface.

9. The computing device of claim 6, wherein the BIOS is to determine the health status of the battery via applying a machine learning model to the updated log data structure, and wherein the updated log data structure is to include the historical information and the obtained information of the battery.

10. The computing device of claim 9, wherein the machine learning model is a classification and regression model.

11. The computing device of claim 6, wherein the battery pack comprises a processor to:
monitor the operation of the battery;
determine the information associated with the operation of the battery; and
store the determined information in the first storage device.

12. A non-transitory computer-readable storage medium encoded with instructions that, when executed by a processor of a computing device, cause the processor to:
initiate a boot process to load an operating system of the computing device;
during the boot process:
obtain information associated with an operation of a battery;
generate a log data structure to record the obtained information;
determine a health status of the battery via applying a machine learning model stored in the computing device to the information in the log data structure; and
store the health status in a storage device of the computing device;
generate a warning message including a criticality level of the battery and a recommendation based on the stored health status; and
output the warning message that is utilized to replace the battery or to charge the battery in accordance with the recommendation.

13. The non-transitory computer-readable storage medium of claim 12, wherein instructions to generate the warning message comprise instructions to:
generate the warning message during the boot process based on the stored health status.

14. The non-transitory computer-readable storage medium of claim 12, wherein instructions to generate the warning message comprise instructions to:
load the operating system of the computing device upon storing the health status;
retrieve the health status of the battery from the storage device via an application programming interface upon loading the operating system; and
generate the warning message based on the retrieved health status.

15. The non-transitory computer-readable storage medium of claim 12, wherein the information associated with the operation of the battery comprises full charge capacity data for the battery, temperature data for the battery, charge cycle data for the battery, charging behavior data for the battery, or any combination thereof.

16. The non-transitory computer-readable storage medium of claim 12, wherein instructions to determine the health status of the battery via applying the machine learning model comprises instructions to:
determine a full charge capacity of the battery via applying a classification and regression model to the information in the log data structure; and
determine the health status of the battery via applying another classification and regression model to the information in the log data structure based on the full charge capacity of the battery.

17. The non-transitory computer-readable storage medium of claim 12, wherein instructions to determine the health status of the battery via applying the machine learning model comprises instructions to:
determine a time period of charge cycle of the battery via applying a classification and regression model to the information in the log data structure; and
determine the health status of the battery via applying another classification and regression model to the information in the log data structure based on the time period of charge cycle of the battery.

18. The non-transitory computer-readable storage medium of claim 12, wherein instructions to determine the health status of the battery via applying the machine learning model comprises instructions to:
determine an internal temperature of the battery via applying a classification and regression model to the information in the log data structure; and
determine the health status of the battery via applying another classification and regression model to the information in the log data structure based on the internal temperature of the battery.

19. The non-transitory computer-readable storage medium of claim 12, further comprising instructions to:
initiate training of the machine learning model during the boot process;
train the machine learning model using a training dataset to generate a set of feature weights corresponding to a set of features of the machine learning model; and
store the set of feature weights in the computing device.

20. The non-transitory computer-readable storage medium of claim 12, wherein instructions to determine the health status of the battery via applying the machine learning model comprise instructions to:
apply a classification and regression model to the log data structure to:
classify the information in the log data structure; and
predict the health status of the battery using the classified information.
